(19) United States
(12) Patent Application Publication
(10) Pub. No.: US 2016/0323273 A1
(43) Pub. Date: Nov. 3, 2016

(54) CONTROLLED SUBSTANCE TRACKING SYSTEM AND METHOD

(71) Applicant: EMS Technology Solutions, LLC, Austell, GA (US)

(72) Inventors: Edward H. Aufderheide, JR., Mableton, GA (US); Oksana Semenska, Port Orange, FL (US); Volodymyr Garvona, Lviv (UA)

(21) Appl. No.: 14/700,842

(22) Filed: Apr. 30, 2015

(51) Int. Cl. H04L 29/06; G06K 9/00

(52) U.S. Cl. CPC H04L 63/0861; G06K 9/00892

(57) ABSTRACT

The present disclosure provides a controlled substance tracking system and method that can be used in the management and transfer of controlled substances in a decentralized utilization system, such as ambulance fleets. The controlled substance tracking system and method provide for biometric identification and verification of individuals involved in the distribution and administration of controlled substances. The system and method can include biometrically verification of each individual responsible for each transaction performed with a controlled substance and logging the transaction event for future tracking and reporting.

### TECHNICAL FIELD

The present disclosure generally relates to the security of controlled substances and, more particularly, for methods and systems of implementing secure transactions of controlled substances.

### BACKGROUND

Controlled substances, such as narcotics, are highly regulated and those whom hold, transfer, and administer those substances are subject to strict record keeping requirements. Controlled substance record keeping regulations include requirements for documenting the transfer, use, destruction, and change in possession of the controlled substance. For operations that handle controlled substances in decentralized settings, such as emergency medical services and fire departments, a particular quantity of a controlled substance can undergo multiple changes in location, possession, and status during the course of a day. Currently, log books must be used to record every update in the status of a controlled substance, but such books are subject to being misplaced, mishandled, or altered, thereby jeopardizing the integrity of the recordkeeping process. Accordingly, there is a need for systems and methods for verifying changes of status of a controlled substance that can address one or more shortcomings of conventional recordkeeping systems.

### SUMMARY

The present disclosure encompasses a computer-implemented method for verifying a controlled substance status update performed by a system comprising at least one processor and a non-transitory computer-readable storage medium storing instructions that, when executed by the at least one processor, cause the system to perform the method, the method comprising the steps of receiving a controlled substance status update request from a user, wherein the controlled substance status update request comprises a controlled substance identifier; receiving a biometric template, wherein the biometric template comprises a user biometric identifier detected by a detecting device; and, comparing, using the at least one processor, the biometric template to at least one stored biometric template stored in a computer-readable database to determine a match between the biometric template and a stored biometric template stored in a database, wherein if the step of comparing the biometric template to a stored biometric template determines a match between the biometric template and a stored biometric template, then performing the step of executing a controlled substance status update. In one aspect, the user biometric identifier can comprise fingerprint data and/or signature data. In another aspect, the method further can comprise the step of generating a verification token. In still another aspect, the method also can comprise the step of sending the verification token to a web page. In still a further aspect, the method can additionally comprise the step of sending a command to the detection device to begin a detection procedure. In yet another aspect, the method further can comprise the step of receiving a second biometric template, wherein the second biometric template comprises a second party biometric identifier detected by the detecting device. In another aspect, the method additionally can comprise the step of comparing, using the at least one processor, the second biometric template to at least one stored biometric template to determine a match between the second biometric template and a stored biometric template. In yet another aspect, if the step of comparing a biometric template to at least one stored biometric template determines a first match between the biometric template and a first stored biometric template and the step of comparing the second biometric template to at least one stored biometric template determines a second match between the second biometric template and a second stored template, then the method can include the step of performing the step of executing a controlled substance status update. In a further aspect, the second party biometric identifier can comprise fingerprint data and/or signature data. In still another aspect, the method can comprise the step of generating a verification token with the verification of the first and second party biometric identifiers. In yet another aspect, the method further can comprise the step of sending the verification token to a web page. In still another aspect, the method can comprise the step of sending a command to the detection device to begin a detection procedure. In still a further aspect, the controlled substance identifier can comprise a control number. In yet another aspect, the method further can comprise the step of receiving a login request from the user. In a further aspect, the step of executing the controlled substance status update comprises the step of updating a transaction database comprising controlled substance transactions.

The present disclosure also encompasses a system for verifying a controlled substance status update comprising: a storage device; and at least one processor coupled to the storage device, wherein the storage device stores a program for controlling the at least one processor, and wherein the at least one processor, being operative with the program, is configured to: receive a controlled substance status update request from a user, wherein the controlled substance status update request comprises a controlled substance identifier, receive a biometric template, wherein the biometric template comprises a user biometric identifier detected by a detecting device, and compare the biometric template to at least one stored biometric template stored in a computer-readable database to determine a match between the biometric template and a stored biometric template stored in a database, wherein if the step of comparing the biometric template to a stored biometric template determines a match between the biometric template and a stored biometric template, then performing the step of executing a controlled substance status update. In another aspect, the processor of the system can be further configured to receive a second biometric template, wherein the second biometric template comprises a second party biometric identifier detected by the detecting device, and to compare the second biometric template to at least one stored biometric template to determine a match between the second biometric template and a stored biometric template, wherein if the second biometric template is a match a stored biometric template, then performing the step of executing a controlled substance status update. In a further aspect, the biometric identifier can comprise signature data and/or fingerprint data. In still another aspect, the processor can be configured to generate a verification token. In yet another aspect, the processor can be configured to send the verification token to a web page.

The present disclosure also encompasses a computer program product having a tangible, non-transitory computer readable medium storing instructions that, when executed by at least one processor, cause the at least one processor to perform a method comprising: receiving a controlled substance status update request from a user, wherein the controlled substance status update request comprises a controlled substance identifier; receiving a biometric template, wherein the biometric template comprises a user biometric identifier detected by a detecting device; and, comparing, using the at least one processor, the biometric template to at least one stored biometric template stored in a computer-readable database to determine a match between the biometric template and a stored biometric template stored in a database, wherein if the step of comparing the biometric template to a stored biometric template determines a match between the biometric template and a stored biometric template, then performing the step of executing a controlled substance status update.

These and other aspects of the present disclosure are set forth in greater detail below and in the drawings for which a brief description is provided as follows.

### BRIEF DESCRIPTION OF THE DRAWINGS

FIG. 1 shows a diagram of a computer (network) system encompassing aspects of the present disclosure.

FIG. 2 shows a sequence diagram illustrating a communication sequence between a user's computer and a web server encompassing aspects of the present disclosure.

FIG. 3 shows a flow diagram illustrating the steps of a method for uploading a biometric template to a user database, wherein the method encompasses aspects of the present disclosure.

FIG. 4 shows a sequence diagram illustrating a sequence for capturing a biometric identifier encompassing aspects of the present disclosure.

FIG. 5 shows a flow diagram illustrating the steps of a method for verifying a controlled substance transfer transaction, wherein the method encompasses aspects of the present disclosure.

FIG. 6 illustrates a screenshot of a user interface request for a biometric identifier that can be employed in a method encompassing aspects of the present disclosure.

FIG. 7 shows a flow diagram illustrating the steps of a method for verifying a biometric identifier in association with the verification of a controlled substance transaction, wherein the method encompasses aspects of the present disclosure.

FIG. 8 shows a flow diagram illustrating the steps of a method for verifying a controlled substance transaction encompassing aspects of the present disclosure.

### DETAILED DESCRIPTION

The present disclosure is directed to systems and computer-implemented methods for verifying the status updates for controlled substances. The systems and computer-implemented methods encompassed by the present disclosure utilize unique controlled substance identifiers associated with particular units of a controlled substance that are assigned to the particular units in order to track the location, transfer, use and disposal of the controlled substance. The systems and computer-implemented methods for verifying transactions involving controlled substances encompassed by the present disclosure can be used in situations where a controlling entity is responsible for the storage, transfer, dispensing, and/or disposal of distinct quantities of controlled substances in a decentralized framework, such as the provision of ambulatory services by emergency medical departments, fire departments, and the like.

As used herein, the term “controlled substance” refers to a drug or chemical compound or product the manufacture, possession, use, prescription, or distribution of which is regulated by a government authority.

As used herein, the term “controlled substance identifier” refers to indicia that identifies and is associated with a particular and uniquely identifiable quantity of a controlled substance.

As used herein, the term “control number” refers to type of controlled substance identifier that includes an alpha/numeric sequence that is assigned to a particular quantity of a controlled substance for tracking and recordkeeping purposes.

As used herein, the term “biometric identifier” refers to a characteristic of an individual person that, when compared to the same characteristic of other individuals, can distinguish that person from other individuals within an acceptable range of probability, and which can include, without limitation, fingerprint data and signature data.

As used herein, the term “biometric template” refers to data that represents at least one biometric identifier of an individual person and that can be uploaded, downloaded, stored, transmitted, and/or compared to other such templates by a computer system comprising a processor.

Typically, once a controlled substance supplier delivers a controlled substance to, for example, an ambulatory service company, the controlled substance can go through several changes of possession and/or location before the controlled substance is either used or destroyed. Particular quantities of a controlled substance are often stored on an ambulance or emergency vehicle in a secured container, typically referred to as a narcotics box. Among the status changes through which a controlled substance can go are: receipt of a controlled substance from a supplier and deposit into a safe; return of a controlled substance from a narcotics box to the safe; issuance of a controlled substance from the safe to a narcotics box; issuance of a controlled substance or a narcotics box to an ambulance crew; return of a controlled substance or a narcotics box from a crew to the safe; transfer of a controlled substance or a narcotics box from one crew to another crew; administration of a controlled substance to a patient; wasting of a controlled substance; report of an incident relating to a controlled substance; transfer of a controlled substance to a destruction box; destruction of a controlled substance and/or clearing of a destruction box; and, return of a controlled substance or narcotics box to the safe. Each event must be carefully recorded, including the logging of those individuals involved in the event. The systems and methods encompassed by the present disclosure can be used to verify users that are involved in one or more such events involving changes of status of a controlled substance.

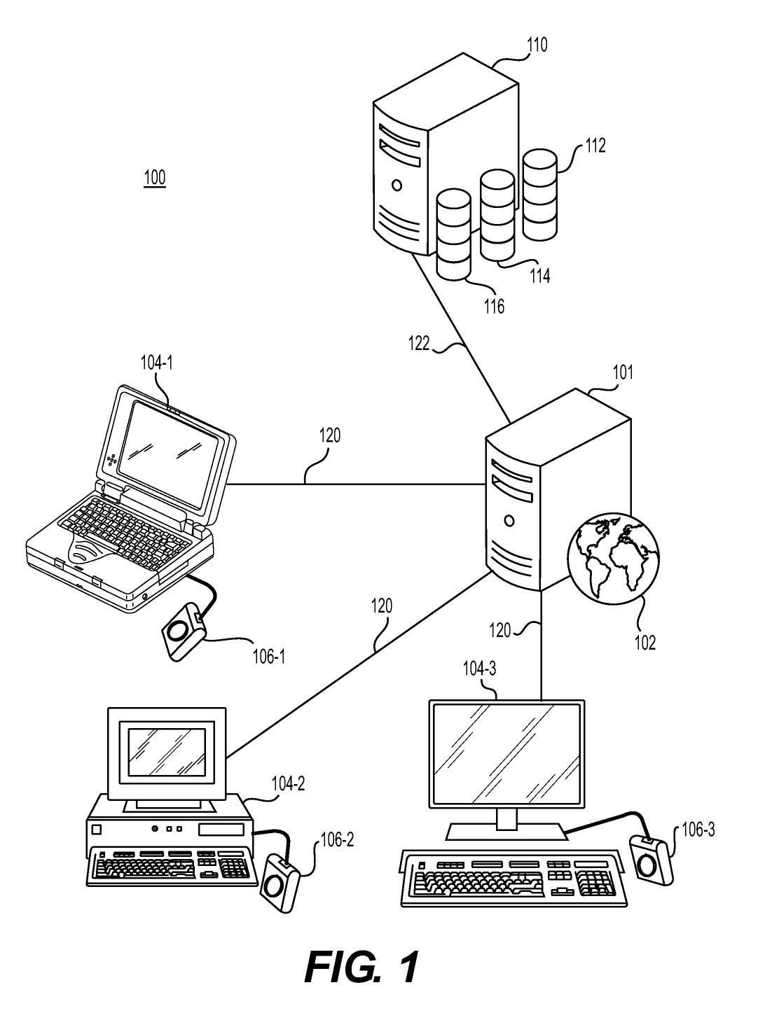

FIG. 1 shows a diagram of a controlled substance tracking system 100 encompassing aspects of the present disclosure and showing the general system design including examples of major hardware and software components, as well as the communication and data flow there between. The infrastructure associated with the system 100 includes a web server 101 operably connected to both a database server 110 and one or more user machines 104-1, 104-2, and 104-3, each of which is operably connected to a biometric reader 106-1, 106-2, 106-3, respectively. The connection of the web server 101 to the one or more user machines 104 can be over the Internet via a secure Internet connection 120 or over another suitable network connection. The web server 101 hosts a controlled substance tracking web application 102. A user, using a user machine 104, can access the web application 102 in order to update an event associated with a controlled substance. The database server 110 can include a user database 112, a transaction database 114 and/or a controlled substance database 116.

The controlled substance tracking system 100 can comprise a wide open website that is accessible by users at any Internet-accessible location and be provided to manage controlled substances and perform change of possession transactions. The system 100 can require that a user be registered prior to logging in to perform a transaction update. To register, a user can be required to provide necessary information to distinguish the user from all other potential users such as, for example, a user name, employee ID, password, and/or digital signature template.

The system 100 can be configured to execute any one or more of several procedures for carrying out the display of data on web pages, processing of web page requests, and /or read/write data to the connected databases 112, 114 and 116. The server side procedures can include one or more of the following, for example: a login procedure in which a user is selected username and password from the user database 112 and stores during the session; an update user information procedure in which either a new user profile is created or an existing profile is updated; a get user information procedure in which user information is obtained by the use of a user ID (integer) from the user database 112, and which can return a set of user properties such as, for example, first name (string), last name(string), employee ID(string), user name(string), digital signature (Binary) and other information; a generate successful verification token procedure in a temporary token is generated and inserted into the transaction database 114, wherein a user ID (integer) is used as a parameter and in which a token (GUID-128 bit Globally Unique Identifier) is created indicating a biometric verification of a user has succeed, and which is stored in the transaction database 114 for a predetermined time period; a validate successful verification token procedure in which a successful verification token is validated to determine if it is valid and exists in the transaction database 114; an update controlled substance possession procedure in which a controlled substance possession is updated in the controlled substance database 116; a save transaction procedure in which transaction information is saved in the transaction database 114 including, for example, transaction date and time, user, second party/witness user, biometric verification, controlled substance possession before the current transaction, controlled substance possession after a particular transaction and others data related to the transaction.

It should be understood that the term “user machine” can be used to refer to any computer or computer system, such as, without limitation, any personal computer, laptop computer, notebook computer, desktop computer, tablet computer, smartphone, wearable computer, personal digital assistant, vehicle-embedded computer, client-side computer, server-side computer, and other such computing device known in the art. An example of a user machine that can be used in the systems and methods encompassed by the present disclosure includes a WINDOWS® 7 operating system, a 2.4 GHz or greater processor 2 GB RAM, an INTERNET EXPLORER® 7.0 web browser, a dedicated graphics card with 256 MB of memory, WDDM 1.1 (WINDOWS® 7) drivers, JAVA® 7 driver, and digital capture software drivers.

The biometric readers 106 can include one or more digital biometric capture devices that can be connected to a user's machine and used to capture a biometric template. The biometric reader 106 can comprise a finger print reader that can be connected to the user machine 104 using a USB or a BLUETOOTH® connection to communicate with the user machine. An example of a device that can be used as a biometric reader in the systems and methods encompasses by the present disclosure is the SecuGen Hamster IV available from the SecuGen Corporation of Santa Clara, Calif. The systems encompassed by the present disclosure can support fingerprint capture formats, such as ANSI INCITS 378, ISO/IEC 19794 and SG400, that allow for the conversion of digital signature images to binary strings. Such a finger print reader that is to be used as a biometric reader in the systems and methods of the present disclosure can require that the appropriate device drivers and/or JAVA® 7 program be installed on the connected user machine.

Another example of a device that can be used as a biometric reader 106 in the systems and methods encompassed by the present disclosure is a digital signature capture device that allows for the use digital ink to create a digitized handwritten signature that can be stored and/or transmitted electronically and that can be compared to other stored digitized handwritten signatures. The digital signature capture device used as a biometric reader 106 can be connected to the user machine 104 using a USB or a BLUETOOTH® connection. An example of a digital signature capture device that can be used as a biometric reader in the systems and methods encompassed by the present disclosure is the T-S460 Model Series SigLite 1×5 electronic signature pad available from Topaz Systems Inc. of Simi Valley, Calif. Yet another example of a biometric reader configuration 106 operably connected to a user machine 104 in the systems and methods encompassed by the present disclosure is a touch screen of the user machine 104, such as are provided on tablet computers and some laptop computers.

The web server 101 of the system 100 is an Internet-connected computer that hosts the controlled substance web application encompassed by the present disclosure. The web server 101 communicates with one or more user machines 104 over a secured Internet connect. The web server 101 host the web application 102 that can be tied to a registered domain name with the Domain Name Server (DNS) operably connected to the web server 101 over the Internet, thereby allowing access by any user machine 104 to the web application over the Internet. An example of a web server that can be used in the systems and methods encompassed by the present disclosure has a 64 bit MICROSOFT® WINDOWS® Server 2008 R2 Enterprise operating system, Internet Information Services (IIS) for WINDOWS®, a MICROSOFT® .NET Framework 4, MICROSOFT® IIS 7.5, including an INTEL® XEON® CPU E5620 2.4 GHz processor, with 24 GB of memory and having a Secure Socket Layer (SSL) Certificate for security and a library for digital signature comparison such as the SecuGen FDx SDK Pro for WINDOWS®.

The web server 101 is operably connected to a database server 110 that can store and process transactions of the systems and methods encompassed by the present disclosure. Like the example of the web server 101, an example of a database server 110 can include MICROSOFT® WINDOWS® Server 2008 R2 Enterprise operating system with an INTEL® XEON® CPU E5620 2.4 GHz processor, and 56 GB of memory. The database server also can include a MICROSOFT® SQL Server® 2008 relational database management system. The web server 101 and the database server 110 can reside on the same physical computer or on a system of networked computers.

The database server 110 hosts the user database 112 that stores user information relevant to the systems and methods of the present disclosure, such as credentials to log into the controlled substance tracking system, various permissions required to access areas of the system 100, general information and stored biometric templates used to verify users of the system and methods. The database server 110 also hosts the transaction database 114 that stores the details of the change of possession transactions, as well as temporary data used for in-process transactions. The database sever 110 additionally hosts the controlled substance database 116 in which is stored information about the unique quantities of controlled substances that are covered by the systems and methods of the present disclosure, including controlled substance identifiers, such as control numbers, current status information and the historical transactional information associated of each controlled substance and/or controlled substance identifier.

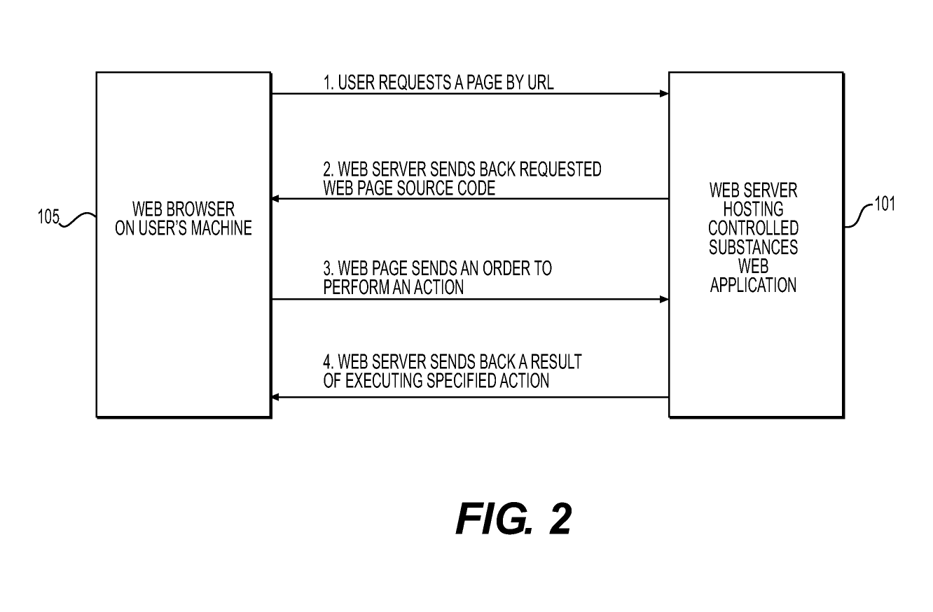

As shown in FIG. 2, the user machine 104 can be used to access the web browser 101 in an access process that begins with the user, through the web browser located on the user machine 104 requesting a web page by URL from the web application 102 hosted on the web server 101. A first time user will go to the login page of the website for verification. To open a page in the web browser 105 located on the user machine 104, the web browser sends a request to the web server 101 specified in the DNS record in order to provide the applicable web page source code. The controlled substance web application 102 hosted on the web server 101 checks if the user is properly logged into the controlled substance tracking system 100 and has the proper permissions to access the requested page. If the user has been properly logged into the system 100 and has the appropriate permissions to access the requested web page, then the web server 101 sends to the web browser 105 the source code necessary for the requested web page to be displayed in the web browser 105 on the user machine 104. When a user performs an action on the user machine 104 to update, insert, or request information from the web page, the web page will send a request to the web server 101 to perform the specified operation. The web browser 105 collects all the data on the web page and sends a request to the web server 101 to process. When the web server 101 receives a request to perform a specified operation from the web page, the controlled substance tracking web application 102 processes the request and sends a result of the action or the requested data back to the web browser 105 on the user machine 104. The possible actions that can be performed by the web application 102 can vary and can include, for example, logging in the user by username and password, in which the web server 101 returns a Boolean result of whether or not the user has been verified and additional user information. Another example is determining whether a biometric template scanned into the user machine 104 is unique in the system 100, in which case the system 100 compares the submitted biometric template to all stored biometric templates accessible by the system 100 and the web server 101 returns a comparison result as a Boolean result to the web browser 105. Yet another example is verifying a person by biometric template, in which case the web server 101 returns to the web browser 105 either a unique verification toke generated by the system 100 if the user has passed the verification process or nothing or nothing if verification failed. Still a further example is committing a controlled substance transaction, in which case the system 100 updates the controlled substance possession in the controlled substance database 116 and the transaction database 114 and returns through the web browser 101 a Boolean result of either true, if the operation was performed successfully, or false, if the attempted transaction failed. The web browser 101 can use different formats to respond to the web browser 105, such as, for example, simple text, XML and/or JSON. The web server 101 prepares the result to the inquiry in the appropriate format and writes the result into Hyper Text Transfer Protocol (HTTP) response, or other suitable web-based protocols, such as Transmission Protocol/Internet Protocol (TCP/IP), SOAP, RMI, RPC or other suitable protocols.

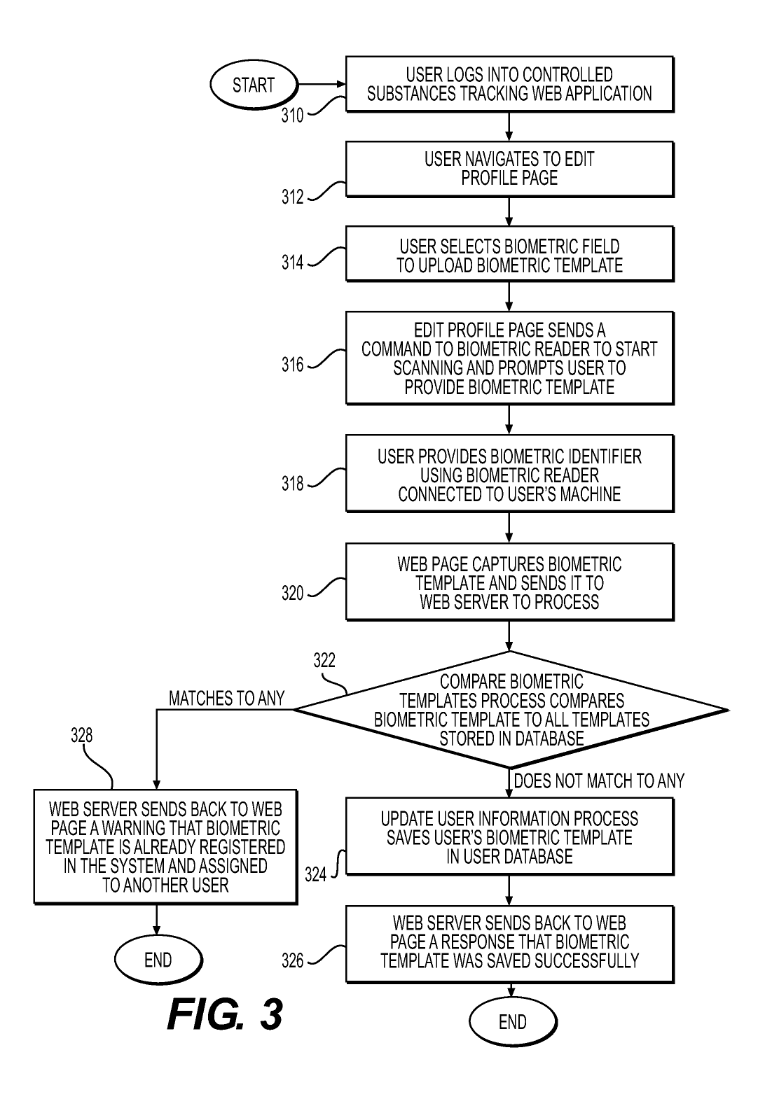

As shown in FIG. 3, the systems and methods encompassed by the present disclosure can include method for uploading a biometric template to a user database 112, wherein the method encompasses aspects of the present disclosure. Using a user machine 104, a first step is a user logs into the controlled substance web application 310, the user then navigates to the Edit Profile page 312 of the controlled substance web application 102. The next step is the user selects a biometric field to upload a biometric template 314. One or more biometric fields can be provided as options by the controlled substance web application 102. The Edit Profile page then sends a command to the biometric reader to start scanning and prompts the user to provide a biometric template 316. The Edit Profile page can contain an Active X or Java Applet that sends the command to the biometric reader 106 operably connected to the user machine 104. The next step is the user provides the biometric identifier to the biometric reader operably connected to the user machine 318. This step can be done by providing the appropriate fingerprint to be scanned by the biometric reader 104 or inputting a handwritten signature that can be captured electronically by the biometric reader 104. Next, the web page captures the biometric template and sends it to the web server to process 320. The biometric template can be produced by the biometric reader 104 upon capturing the biometric identifier provided by the user. The biometric template can then by captured by the web page, that can contain the suitable applet for carrying out this process, and then sent to the web server 101 by the web page. The next step is that the system compares the biometric template to all biometric templates stored in the user database 322. If the biometric template that is being compared matches to any stored biometric template, then the system will take the step of the web server sends back to the web page a warning that the biometric template is already registered in the system and assigned to another user 328. Thus, preventing the biometric template to be associated with the user that commenced the process. However, if the biometric template does not match any of the stored biometric templates, then the system will take the step of update the user information by saving the user's biometric template to the user database 324. The next step will then be the web server sends back to the web page a response that the biometric template was saved successfully 326. By this method, a user can be entered into the system 100 and allowed to conduct controlled substance transactions using the verification systems and methods encompassed hereby.

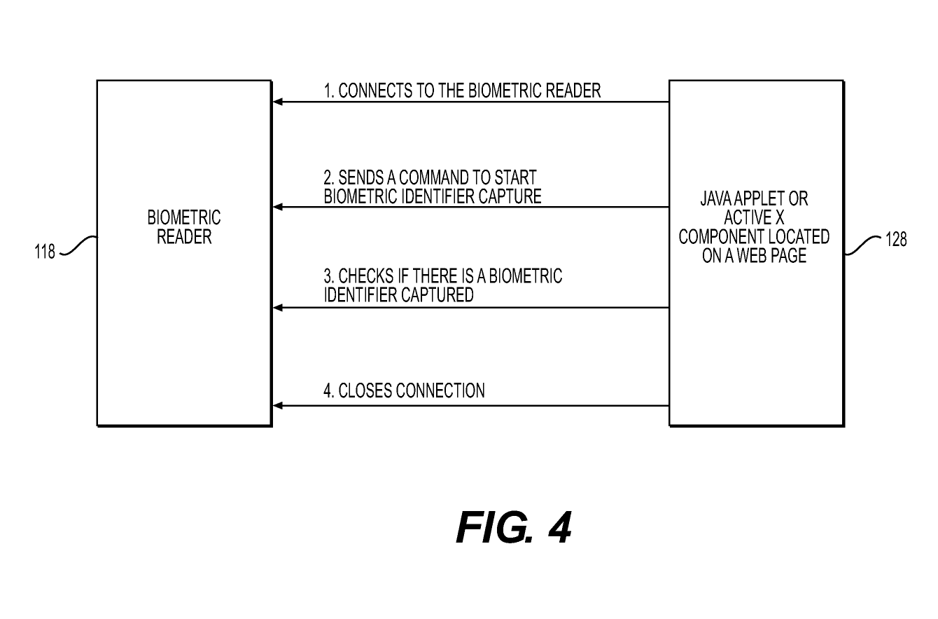

FIG. 4 depicts an example sequence of communication between a biometric reader 106 and the JAVA® applet or the Active X component 128 located on the web page presented to the web browser 105 of the user machine 104. Upon any sequence in which the appropriate next step is the submission of a biometric template to the system 100, the JAVA® applet or the Active X 128 component located on the web page will connect with the biometric reader 118 and send a command to start the capture of the appropriate biometric identifier. The JAVA® applet or the Active X 128 component located on the web page will then check to confirm if a biometric identifier has been captured and then will close the connection. The sequence depicted in FIG. 4 can be required before a controlled substance transaction can be updated in the systems and methods encompassed by the present disclosure. Examples of a JAVA® applet or an Active X component that can be used the systems and methods encompassed hereby are SecuGen JAVA® applet and SecuGen Active X, each provided by SecuGen. The appropriate reader drivers provided with the biometric reader 106 can be installed on the user machine 104 to allow for efficient communication between the biometric reader 106, the user machine 104, and the web server 101. After the command to capture a biometric identifier is sent, the JAVA® applet or an Active X component can recheck approximately every 200 milliseconds to determine if a biometric identifier has been captured. The JAVA® applet or an Active X component 128 can convert the image of the biometric identifier produced by the biometric reader 128 into a usable binary formatted biometric template using an appropriate format, such as, for example ANSI 3738, ISO 19794, or SG 400. The binary formatted biometric template can then be passed to the web page by the JAVA® applet or an Active X component and returned to the web server 101 for processing by the system 100.

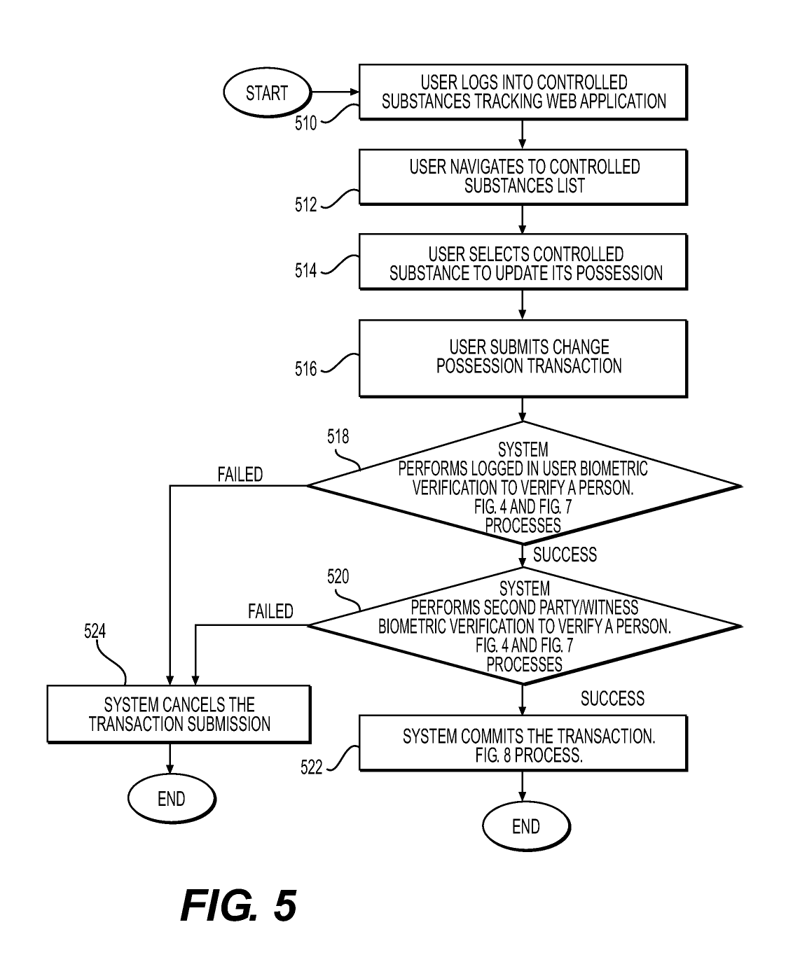

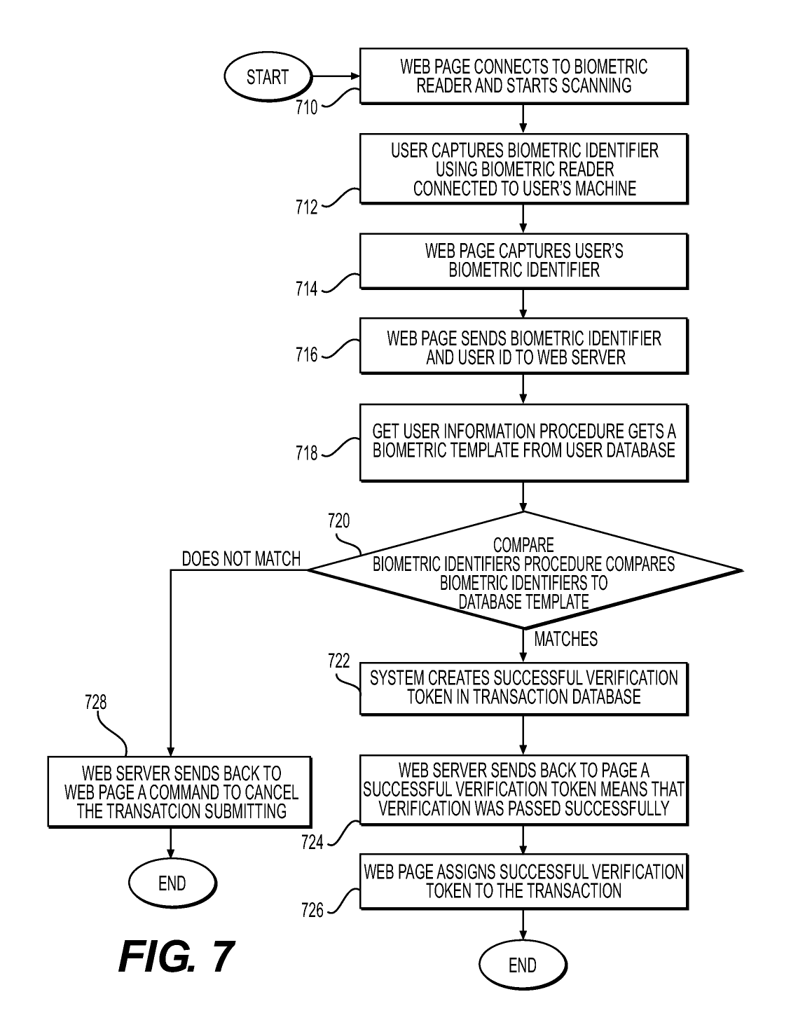

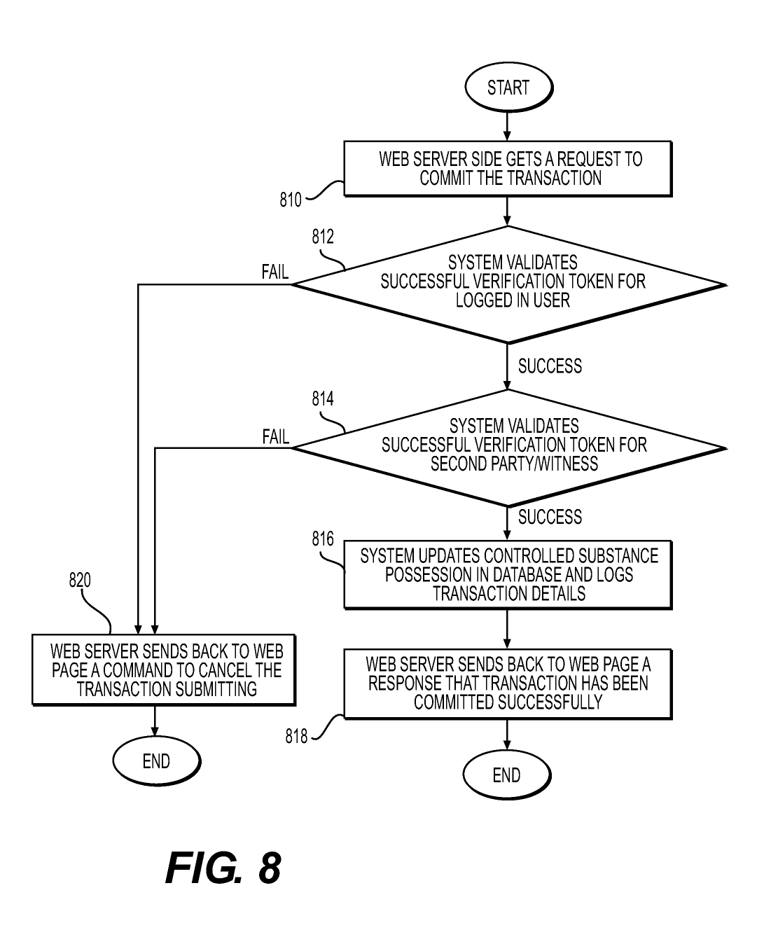

FIG. 5 depicts a method for verifying a controlled substance transfer transaction encompassing aspects of the present disclosure. The method can include a first step of user logs into the controlled substance tracking web application 510. This login step can be conducted using a user machine 104 over a secure Internet connection 120 to the web server 101. The next step is the user navigates to the controlled substances list 512, which can be located on the web page provided by the web server 101 to the user machine 104. The user selects the controlled substance for which possession is to be updated 514. The controlled substances that are managed by the system 100 can be presented for selection by control number or other suitable controlled substance identifier. The user then submits a change possession transaction request 516, whereby the web page sends the request to the webserver 101. In the next step, the system performs the logged in user biometric identification to verify the person acting as the user 518. The step includes the steps set forth in the processes outlined in FIGS. 4 and 7. If the overall user biometric verification process fails to verify the user, then the system cancels the transaction submission 524. However, the if the user biometric verification process verifies the user, then the system performs a second party/witness biometric verification process 520 to verify the identity of the person acting as the witness to the controlled substance transaction. The step of biometric verification of the second party/witness also can involve the processes depicted in FIGS. 4 and 7. If the step of the second party/witness biometric verification succeeds then the system commits the transaction according to the process depicted in FIG. 8 522. In this manner, a controlled substance transaction can be duly conducted and recorded with the identity of the persons involved in the transaction verified and verified using biometric identifiers. In some embodiments, the systems and methods encompassed by the present disclosure can require that the method depicted in FIG. 5 be conducted before a status update to a controlled substance is made or recorded, thereby requiring the biometric authorization of the user initializing the transaction update and the witness to the transaction. The controlled substance transaction set forth in the method depicted in FIG. 5 can be any one or more of the instances of a change in status of a controlled substance described herein including, but not limited to, a change in location, transfer between individuals, administration, wasting, and/or disposal of the controlled substance. The method depicted in FIG. 5 can accommodate either two parties involved in the controlled substance transaction, such as the transfer of the controlled substance from one party to another, or a single party to the transaction with another person acting as a witness to the transaction, such as the administration or disposal of the controlled substance. In each case, in addition to the user, the second party or witness can also be registered previously in the system 100 so that a stored biometric template corresponding to the second party or witness's biometric identifier already exists in the user database 112.

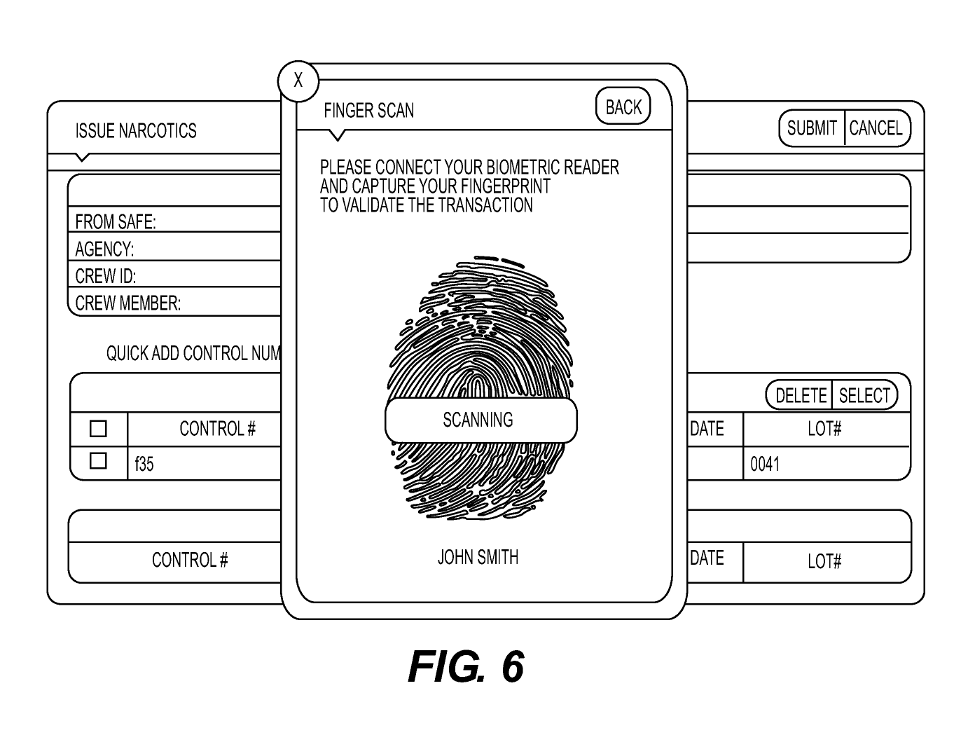

FIG. 6 illustrates a screenshot of a web page provided by the controlled substance web application 102 sent by the web server 101 to a user machine 104 after the user has logged into the web application 102. On this web page, the user has selected a controlled substance to be issued to the user. The user has pressed the “Save” button to submit the controlled substance transaction to the system 100; but before the transaction can be successfully submitted and recorded, the web server 101 has prompted the user to proceed through a user biometric verification process, which must be completed successfully in order for the transaction to be updated successfully by the system 100. The JAVA® applet or Active X component located on the web page has been initialized, connected to the biometric reader 128, which, as shown in FIG. 6, is a fingerprint reader and sent a command to the biometric reader 128 to start scanning the user's fingerprint, thereby capturing the biometric identifier of the user. The web page is awaiting the scanning of a fingerprint by the fingerprint reader. Once an image of a fingerprint is received by the web page, the web page will close the dialog panel depicted in FIG. 6. Since the issuance of a controlled substance involves two parties, the issuer and the receiver, upon the biometric verification of the user, the web page will prompt the input of the second party biometric identifier into the biometric reader 128 for biometric verification of the second party, as in step 520 depicted in FIG. 5. When both biometric verification steps have been completed successfully, the web page submits the transaction for the issuance of the controlled substance to the user to the web server to update controlled substance possession by the database server in the controlled substance database 116 and the transaction database 114.

FIG. 7 depicts a method for verifying a biometric identifier in association with the verification of a controlled substance transaction, wherein the method encompasses aspects of the present disclosure. In the first step of the method, the web page connects to the biometric reader and starts scanning 710. In the next step, the user captures the user biometric identifier using the biometric reader connected to the user machine 712. This step is followed by the step wherein the web page captures the user's biometric identifier 714. The web page then sends the biometric identifier and User ID to the web server 716. The method then includes a step of a get user information procedure in which the controlled substance web application gets a biometric template form the user database 718. In the next step, the biometric identifier represented in the generated biometric template is compared to the stored biometric templates stored in the user database 720. If the biometric template being compared does not match any stored biometric template, then the web server sends back to the web page a command to cancel the transaction being submitted 728. However, if the biometric template being compared matches a stored biometric template then the system creates a successful verification toke in the transaction database 722. The web server then sends back to the web page a successful verification token indicating that the biometric verification process was passed successfully 724. In the next step, the web page assigns the successful verification token to the transaction.

In this method, when the user submits a controlled substance transaction for processing by the system 100, the web page sends a dialog window to the user machine 104 to request a scan or capture of the appropriate biometric identifier of the user. When the biometric identifier digital image is captured the JAVA® applet or an Active X component located on the web page sends the biometric template in a binary format along with the User ID, which can be a user name and password combination or other suitable non-biometric identifier. The system 100 uses the biometric template to get the user's information from the user database 112, including the appropriate stored biometric template for the user. The step of comparing the submitted biometric template to the stored biometric templates uses external libraries containing appropriately formatted biometric identifier data, such as, for example, fingerprint data for comparison. An example of such an external library is the SecuGen FDx SDK Pro. The result of the comparison process is the return of a Boolean result either indicating success or failure of the user biometric verification process. If the comparison is successful and a successful verification token is generated, then the successful verification token is assigned to the particular user and stored in the transaction database 114. The successful verification token will be active for a predetermined amount of time or until the transaction is completed. When the successful verification token is generated, it can be stored in a hidden field by the webpage and can remain active while the transaction is in process. The successful verification token provided on the web page can match the successful verification token stored on the server side of the system 100 in the transaction database 114.

FIG. 8 depicts a method for verifying a controlled substance transaction encompassing aspects of the present disclosure. The method includes a step wherein the web server side gets a request to commit a controlled substance transaction 810. In the next step, the system validates a successful verification token for the logged in user 812. If the validation fails, then the web server sends back to the web page a command to cancel the transaction submission 820. However, if the validation succeeds, then in the next step the system validates a successful verification token for a second party or witness. If this second validation fails, then the method returns to the step of canceling the transaction submission 820. However, if the second validation succeeds, then in the next step the system updates the controlled substance database and logs the transaction details 816. In the next step, the web server sends back to the web page a response that the transaction has been committed successfully 818.

After the biometric verification process has been completed, the web page sends to the web server 101 information regarding, for example, the particular controlled substance registered in the controlled substance database 116, the proposed update to be applied to the particular controlled substance, the user performing the transaction, the second party or witness, the description of the transaction, the successful verification token for the user, and/or the successful verification token for the second party or witness. The server side validation step ensures that a biometric verification has succeeded as to the current transaction and exists in an active state in the transaction database 114. The successful verification token can be invalid when too much time has elapsed between verification and submission of the transaction, or when the successful verification token does not exist in the transaction database 114 raising the possibility that the user manually modified the web page inserting a random token in an attempt to circumvent the verification procedure.

When both successful verification tokens are determined to be valid, the system 100 executes the update controlled substance possession procedure to change controlled substance possession in the controlled substance database 116 and the transaction database 114. The system 100 then executes a deactivate successful verification token procedure to deactivate the tokens. If a user wants to submit another transaction to the system 100, then the user must go through another biometric verification process for the new transaction. The system 100 stores all the details of a completed and successful transaction in the transaction database 114, using a save transaction procedure, in which information such as, for example, the date and time of submission, user, second party or witness, details of the biometric verification process and any other pertinent transaction information.

The systems and methods encompassed by the present disclosure can be embodied in any suitable computer system, network, or other environment or application in which the system components can be configured and operated to execute the operations and steps set forth herein. The systems and methods encompassed by the present disclosure can be implemented in a computer program product, such as, for example a computer program tangibly embodied in a machine-readable storage device for execution by a computer. Such a computer program product can be written in any appropriate programming language and deployed in any usable form.

Other embodiments of the present disclosure will be apparent to those of skill in the art after review of the present disclosure. The embodiments set forth herein are to be considered exemplary in nature and not limiting of the present disclosure, the scope of which is indicated by the claims set forth herein below.

1. A computer-implemented method for verifying a controlled substance status update performed by a system comprising at least one processor and a non-transitory computer-readable storage medium storing instructions that, when executed by the at least one processor, cause the system to perform the method, the method comprising:
receiving a controlled substance status update request from a user, wherein the controlled substance status update request comprises a controlled substance identifier;
receiving a biometric template, wherein the biometric template comprises a user biometric identifier detected by a detecting device; and,
comparing, using the at least one processor, the biometric template to at least one stored biometric template stored in a computer-readable database to determine a match between the biometric template and a stored biometric template stored in a database, wherein if the step of comparing the biometric template to a stored biometric template determines a match between the biometric template and a stored biometric template, then performing the step of executing a controlled substance status update.

2. The method of claim 1, wherein the user biometric identifier comprises fingerprint data.

3. The method of claim 1, wherein the user biometric identifier comprises signature data.

4. The method of claim 1, further comprising the step of generating a verification token.

5. The method of claim 4, further comprising the step of sending the verification token to a web page.

6. The method of claim 1, further comprising the step of sending a command to the detection device to begin a detection procedure.

7. The method of claim 1, further comprising the step of receiving a second biometric template, wherein the second biometric template comprises a second party biometric identifier detected by the detecting device.

8. The method of claim 7, further comprising the step of comparing, using the at least one processor, the second biometric template to at least one stored biometric template to determine a match between the second biometric template and a stored biometric template.

9. The method of claim 8, wherein if the step of comparing a biometric template to at least one stored biometric template determines a first match between the biometric template and a first stored biometric template and the step of comparing the second biometric template to at least one stored biometric template determines a second match between the second biometric template and a second stored template, then performing the step of executing a controlled substance status update.

10. The method of claim 7, wherein the second party biometric identifier comprises fingerprint data.

11. The method of claim 7, wherein the second biometric identifier comprises signature data.

12. The method of claim 9, further comprising the step of generating a verification token.

13. The method of claim 12, further comprising the step of sending the verification token to a web page.

14. The method of claim 7, further comprising the step of sending a command to the detection device to begin a detection procedure.

15. The method of claim 1, wherein the controlled substance identifier comprises a control number.

16. The method of claim 1, further comprising the step of receiving a login request from the user.

17. The method of claim 1, wherein the step of executing the controlled substance status update comprises the step of updating a transaction database comprising controlled substance transactions.

18. A system for verifying a controlled substance status update comprising: a storage device; and at least one processor coupled to the storage device, wherein the storage device stores a program for controlling the at least one processor, and wherein the at least one processor, being operative with the program, is configured to: receive a controlled substance status update request from a user, wherein the controlled substance status update request comprises a controlled substance identifier, receive a biometric template, wherein the biometric template comprises a user biometric identifier detected by a detecting device, and compare the biometric template to at least one stored biometric template stored in a computer-readable database to determine a match between the biometric template and a stored biometric template stored in a database, wherein if the step of comparing the biometric template to a stored biometric template determines a match between the biometric template and a stored biometric template, then performing the step of executing a controlled substance status update.

19. The system of claim 18, wherein the processor is further configured to receive a second biometric template, wherein the second biometric template comprises a second party biometric identifier detected by the detecting device, and to compare the second biometric template to at least one stored biometric template to determine a match between the second biometric template and a stored biometric template, wherein if the second biometric template is a match a stored biometric template, then performing the step of executing a controlled substance status update.

20. The system of claim 18, wherein the biometric identifier comprises signature data.

21. The system of claim 18, wherein the biometric identifier comprises fingerprint data.

22. The system of claim 18, wherein the processor is configured to generate a verification token.

23. The method of claim 22, wherein the processor is configured to send the verification token to a web page.

24. A computer program product having a tangible, non-transitory computer-readable medium storing instructions that, when executed by at least one processor, cause the at least one processor to perform a method comprising: receiving a controlled substance status update request from a user, wherein the controlled substance status update request comprises a controlled substance identifier;
receiving a biometric template, wherein the biometric template comprises a user biometric identifier detected by a detecting device; and,
comparing, using the at least one processor, the biometric template to at least one stored biometric template stored in a computer-readable database to determine a match between the biometric template and a stored biometric template stored in a database, wherein if the step of comparing the biometric template to a stored biometric template determines a match between the biometric template and a stored biometric template, then performing the step of executing a controlled substance status update.
